(19) United States
(12) Patent Application Publication
(10) Pub. No.: US 2024/0343604 A1
(43) Pub. Date: Oct. 17, 2024

(54) METHOD OF MANUFACTURING POSITIVE ELECTRODE ACTIVE MATERIAL, METHOD OF MANUFACTURING SODIUM ION BATTERY, POSITIVE ELECTRODE ACTIVE MATERIAL, AND SODIUM ION BATTERY

(71) Applicant: TOYOTA JIDOSHA KABUSHIKI KAISHA, Toyota-shi (JP)

(72) Inventors: Shohei KAWASHIMA, Susono-shi (JP); Jun YOSHIDA, Susono-shi (JP); So Yubuchi, Sunto-gun (JP); Satoshi Wakasugi, Susono-shi (JP)

(73) Assignee: TOYOTA JIDOSHA KABUSHIKI KAISHA, Toyota-shi (JP)

(21) Appl. No.: 18/624,597

(22) Filed: Apr. 2, 2024

(30) Foreign Application Priority Data
Apr. 14, 2023 (JP) 2023-066525

(51) Int. Cl. C01G 53/00; H01M 4/02; H01M 4/505; H01M 4/525; H01M 10/054

(52) U.S. Cl. CPC C01G 53/50; H01M 4/505; H01M 4/525; H01M 10/054; C01P 2002/54; C01P 2002/72; C01P 2006/40; H01M 2004/028

(57) ABSTRACT

Disclosed is a method of increasing the capacity of a P2 type positive electrode active material. A method of manufacturing a positive electrode active material of the present disclosure includes obtaining a Na containing transition metal oxide having a P2 type structure, and further doping the Na containing transition metal oxide with Na.

### FIELD

The present application discloses a method of manufacturing a positive electrode active material, a method of manufacturing a sodium ion battery, a positive electrode active material, and a sodium ion battery.

### BACKGROUND

As disclosed in PTL 1, a Na containing transition metal oxide having a P2 type structure is known as a positive electrode active material. For example, a Na containing transition metal oxide having a P2 type structure is used as a positive electrode active material of a sodium-ion battery.

### CITATION LIST

### Patent Literature

[PTL 1] JP 2012-201588 A

### SUMMARY

### Technical Problem

It is difficult to say that the potential for the reversible capacitance is sufficiently drawn in the conventional positive electrode active material having a P2 type structure.

### Solution to Problem

As a means for solving the above problem, the present application discloses the following plurality of aspects.

### <Aspect 1>

A method of manufacturing a positive electrode active material, the method comprising: obtaining a Na containing transition metal oxide having a P2 type structure, and further doping the Na containing transition metal oxide with Na.

### <Aspect 2>

The method according to Aspect 1, wherein
the Na containing transition metal oxide is further doped with Na by bringing a reducing solution comprising Na ions into contact with the Na containing transition metal oxide.

### <Aspect 3>

A method of manufacturing a sodium ion battery, the method comprising:
producing a positive electrode active material by the method according to Aspect 1 or 2,
using the positive electrode active material to obtain a positive electrode active material layer, and
using the positive electrode active material layer to obtain a sodium ion battery.

### <Aspect 4>

A positive electrode active material,
having a P2 type structure, and
having a chemical composition represented by NaₐMnₓ₋ₚNi_{y-q}Co_{z-r}M_{p+q+r}O₂ (where, 0.70≤a≤1.40, x+y+z=1, 0≤p+q+r<0.17, M is at least one of B, Mg, Al, K, Ca, Ti, V, Cr, Fe, Cu, Zn, Ga, Ge, Sr, Y, Zr, Nb, Mo and W).

### <Aspect 5>

A sodium ion battery, comprising a positive electrode active material layer, an electrolyte layer, and a negative electrode active material layer, wherein
the positive electrode active material layer comprises a positive electrode active material according to Aspect 4.

### EFFECTS

The positive electrode active material of the present disclosure has a high capacity.

### BRIEF DESCRIPTION OF DRAWINGS

FIG. 1 shows an example of a flow of a method of manufacturing a positive electrode active material.

FIG. 2 shows an example of the flow of a method of manufacturing a sodium ion battery.

FIG. 3 schematically shows an example of a configuration of a sodium ion battery.

FIG. 4 shows the X-ray diffraction pattern of the positive electrode active material of each of Comparative Example, Example 1 and Example 2.

### DESCRIPTION OF EMBODIMENTS

### 1. Method of Manufacturing Positive Electrode Active Material

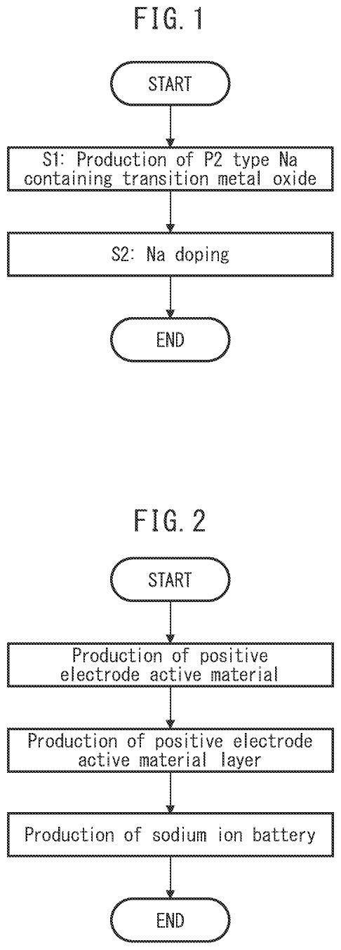

As shown in FIG. 1, a method of manufacturing a positive electrode active material according to an embodiment includes obtaining a Na containing transition metal oxide having a P2 type structure (step S1), and further doping the Na containing transition metal oxide with Na (step S2).

### 1.1 Step S1

In the step S1, a Na containing transition metal oxide having a P2 type structure can be obtained by, for example, obtaining a precursor containing Na and a transition metal element, optionally shaping the precursor, and optionally pre-firing the precursor, and then performing main firing.

In the step S1, the precursor may be obtained, for example, by mixing a transition metal source and a Na source. The transition metal source, for example, may be a transition metal salt such as a carbonate, a sulfate, a nitrate, or an acetate, or may be a transition metal compound such as a transition metal hydroxide. The transition metal element may be at least one of Mn, Ni, and Co. The transition metal source may be a salt represented by Me(CO₃)ₓ (Me is at least one transition metal element among Mn, Ni, and Co, and x depends the valence of Me), may be a salt represented by Me(SO₄)ₓ, may be a salt represented by Me(NO₃)ₓ, may be a salt represented by Me(CH₃COO)ₓ, or may be a compound represented by Me(OH)ₓ. The Na source, for example, may be a Na salt such as a carbonate or a sulfate, or may be a Na compound such as sodium oxide or sodium hydroxide. The amount of the Na source mixed with the transition metal source may be determined by taking into account the amount of Na lost during subsequent firing. In the step S1, surfaces of particles composed of the above transition metal source may be coated with the Na source to obtain coated particles as the precursor. The coated particles may be obtained by coating at least a portion of the surfaces of particles composed of the above transition metal source with the Na source. The coated particles may be obtained by coating 40% by area or greater, 50% by area or greater, 60% by area or greater, or 70% by area or greater of the surfaces of particles composed of the above transition metal source with the Na source.

In the step S1, the precursor may be obtained, for example, by mixing an M source comprising an element M in addition to a transition metal source and a Na source. The element M is at least one selected from B, Mg, Al, K, Ca, Ti, V, Cr, Fe, Cu, Zn, Ga, Ge, Sr, Y, Zr, Nb, Mo, and W. By including the element M, the P2-type structure can be further stabilized. The M source, for example, may be a salt such as a nitrate, a sulfate, a carbonate, or an acetate, or may be a compound other than a salt, such as a hydroxide. The amount of the M source in the precursor may be appropriately determined in accordance with the target composition of the Na-containing transition metal oxide after firing.

In the step S1, the precursor may be obtained, for example, by obtaining a precipitate using an ion source that can form a precipitation with a transition metal ion in an aqueous solution and a transition metal compound, and then mixing the precipitate with a Na source and optionally an element M source. Examples of the ion source that can form a precipitate with a transition metal ion include sodium salts such as sodium carbonate and sodium nitrate, sodium hydroxide, and sodium oxide. Examples of the transition metal compound include salts such as nitrates, sulfates, carbonates, and acetates and hydroxides. In the step S1, the ion source and the transition metal compound may each be formed into a solution, and the solutions may then be dropped and mixed to obtain a precipitate. In this case, various sodium compounds may be used as a base, and ammonia aqueous solution may be added to adjust basicity. More specifically, in the step S1, a precipitate comprising at least one transition metal element among Mn, Ni, and Co may be obtained. The precipitate can be obtained, for example, by a solution method such as a coprecipitation method or a sol-gel method. In the case of a coprecipitation method, the precipitate is obtained, for example, by preparing an aqueous solution of Me(SO₄)ₓ and an aqueous solution of Na₂CO₃ and dropping to mix the aqueous solutions. After collecting the precipitate, the precipitate may be mixed with a Na source. The amount of the Na source to be mixed with the precipitate may be determined by taking into account the amount of Na lost during subsequent firing. In addition, surfaces of particles composed of the precipitate may be coated with the Na salt to obtain coated particles as the precursor. The coverage of the coated particles is as described above.

In the step S1, pre-firing of the precursor obtained as described above may be carried out at temperatures of main firing or less. For example, pre-firing can be carried out at a temperature of less than 700° C. The pre-firing time is not particularly limited. Alternatively, pre-firing may be omitted.

In the step S1, main firing of the precursor may be carried out at a temperature of, for example, 700° C. or higher and 1100° C. or lower, and preferably 800° C. or higher and 1000° C. or lower. When the main firing temperature is too low, Na doping is not carried out. When the main firing temperature is too high, O3-type structure, not P2-type structure, is easily generated.

The heating conditions from the pre-firing temperature to the main firing temperature are not particularly limited. The main firing time is also not particularly limited, and for example, may be 30 min or more and 10 h or less. The main firing atmosphere is not particularly limited, and for example, may be an oxygen-containing atmosphere such as an ambient air atmosphere or an inert gas atmosphere.

In the step S1, after the above main firing, a Na-containing transition metal oxide having a P2-type structure may be doped with the above element M. Specifically, a Na-containing transition metal oxide having a P2-type structure not comprising the element M is synthesized, and then the oxide may be doped with the element M. The doping with the element M may be carried out, for example, by ion exchange.

The Na-containing transition metal oxide having a P2 type structure obtained by the step S1, for example, may comprise at least one element among Mn, Ni, and Co; Na; and O as constituent elements. Particularly, when at least Na, Mn, at least one of Ni and Co, and O are included as constituent elements, especially when at least Na, Mn, Ni, Co, and O are included as constituent elements, performance of the positive electrode active material tends to be even higher. More specifically, the Na-containing transition metal oxide obtained by the step S1 may have a chemical composition represented by Na_{c}Mnₓ₋ₚNi_{y-q}Co_{z-r}M_{p+q+r}O₂ (where 0<c≤0.70; x+y+z=1; and 0≤p+q+r<0.17, and the element M is at least one selected from B, Mg, Al, K, Ca, Ti, V, Cr, Fe, Cu, Zn, Ga, Ge, Sr, Y, Zr, Nb, Mo, and W). When the Na containing transition metal oxide has such a chemical composition, a P2-type structure is easily maintained. In the above chemical composition, c may be greater than 0, 0.10 or greater, 0.20 or greater, 0.30 or greater, 0.40 or greater, 0.50 or greater, or 0.60 or greater. In addition, x may be 0 or greater, 0.10 or greater, 0.20 or greater, 0.30 or greater, 0.40 or greater, or 0.50 or greater, and may be 1.00 or less, 0.90 or less, 0.80 or less, 0.70 or less, 0.60 or less, or 0.50 or less. Further, y may be 0 or greater, 0.10 or greater, or 0.20 or greater, and may be 1.00 or less, 0.90 or less, 0.80 or less, 0.70 or less, 0.60 or less, 0.50 or less, 0.40 or less, 0.30 or less, or 0.20 or less. Moreover, z may be 0 or greater, 0.10 or greater, 0.20 or greater, or 0.30 or greater, and may be 1.00 or less, 0.90 or less, 0.80 or less, 0.70 or less, 0.60 or less, 0.50 or less, 0.40 or less, or 0.30 or less. The element M has a small contribution towards charging-discharging. In this regard, in the above chemical composition, by having p+q+r less than 0.17, a high charging-discharging capacity is easily ensured. p+q+r may be 0.15 or less, 0.13 or less, 0.11 or less, 0.09 or less, 0.07 or less, 0.06 or less, 0.05 or less, or 0.04 or less. By including the element M, a P2-type structure is easily stabilized. In this regard, in the above chemical composition, p+q+r is 0 or greater, and may be greater than 0, 0.01 or greater, 0.02 or greater, or 0.03 or greater. The composition of O is approximately 2, but may be variable without being limited to exactly 2.0.

### 1.2 Step S2

By passing through the above step S1, a Na containing transition metal oxide having a P2 type structure can be obtained. However, according to the findings of the present inventor, only after the above-described step S1, it is difficult for Na content in the Na containing transition metal oxide to be sufficient. For example, the molar ratio of Na (above described “a”) in the Na containing transition metal oxide after firing described above is only 0.70 or less, and the potential of the reversible capacity of P2 type positive electrode active material cannot be sufficiently extracted.

In contrast, in the step S2, by further doping the Na containing transition metal oxide obtained by the above step S1 with Na, the molar ratio of Na (above described “a”) in the Na containing transition metal oxide can be increased to more than 0.70. In the step S2, for example, it is preferable that the Na containing transition metal oxide be further doped with Na without applying a driving force by voltage (that is, charging/discharging of a battery). For example, the Na containing transition metal oxide may be doped with Na by bringing a Na doping source into contact with the Na containing transition metal oxide.

Specifically, in the step S2, it is preferable that the Na containing transition metal oxide be further doped with Na by bringing a reducing solution comprising Na ions into contact with the Na containing transition metal oxide. A “reducing solution” means a solution having reducing properties, and for example, may be a solution comprising an electrophile. The reducing solution, for example, may be obtained by dissolving an electrophile and a Na source in a solvent. Various organic solvents capable of dissolving an electrophile and a Na source can be adopted as the solvent. The solvent is preferably, for example, an ether solvent such as tetrahydrofuran or dimethoxyethane. As the electrophile, various substances which dissolve in the above solvent may be adopted. The electrophile is preferably an aromatic organic compound such as biphenyl. Na source may be any of a variety of materials which dissolve in the above solvents to produce Na ions. Na source may be a metallic sodium or may be a Na compound.

The concentrations of the electrophile and the Na ions contained in the reducing solution may be appropriately determined in accordance with the target doping amount. According to the findings of the present inventors, the larger the amount of Na ions contained in the reducing solution relative to the amount of the Na containing transition metal oxide in contact with the reducing solution, the larger the doping amount of Na relative to the Na containing transition metal oxide tends to be. For example, when the above Na containing transition metal oxide is immersed in a reducing solution, the molar ratio (Na ions/Na containing transition metal oxide) of Na ions contained in the reducing solution to Na containing transition metal oxide immersed in the reducing solution may be 0.1 or greater, 0.2 or greater, 0.3 or greater, 0.4 or greater, 0.5 or greater, 0.6 or greater, 0.7 or greater, or 0.8 or greater, and may be 2.0 or less, 1.5 or less, 1.0 or less, 0.9 or less, 0.8 or less, 0.7 or less, 0.6 or less, 0.5 or less, 0.4 or less, 0.3 or less, or 0.2 or less. Particularly, when the molar ratio (Na ions/Na containing transition metal oxide) is 0.1 or greater and 0.8 or less, a positive electrode active material having excellent performance is easily obtained. The molar ratio (electrophile/Na ions) of the electrophile to the Na ions contained in the reducing solution is not particularly limited, and for example, may be 0.5 or more and 2.0 or less, 0.7 or more and 1.5 or less, or 0.9 or more and 1.1 or less.

In the step S2, the Na containing transition metal oxide can be further doped with Na, for example, simply by bringing the Na containing transition metal oxide into contact with the reducing solution described above. The contact state between the reducing solution and the Na containing transition metal oxide is not particularly limited. For example, the Na containing transition metal oxide may be immersed in the reducing solution. Alternatively, the reducing solution may be sprayed onto the Na containing transition metal oxide. The temperature during contact is also not particularly limited, and heating may or may not be used. Stirring may be carried out after the Na containing transition metal oxide is immersed in the reducing solution.

The time in which the Na containing transition metal oxide is brought into contact with the reducing solution is not particularly limited, and may be appropriately determined in accordance with the target doping amount. The contact time, for example, may be 1 min or more, 30 min or more, or 1 h or more, and may be 48 h or less, 40 h or less, or 30 h or less.

### 2. Positive Electrode Active Material

From the foregoing, a positive electrode active material having a P2 type structure (P2 type Na containing transition metal oxide) having a larger Na amount than in the prior art and a high capacity can be manufactured through the steps S1 and S2. The positive electrode active material obtained via the steps S1 and S2, for example, may have the following characteristics.

### 2.1 Crystal Structure

The positive electrode active material has at least a P2 type structure (belonging to the space group P63mc). The positive electrode active material may have a P2 type structure and a crystal structure other than a P2 type structure. Examples of the crystal structure other than P2 type structure include various crystal structures formed when Na is de-inserted from P2 type structure (for example, P3 type structure and the like). The positive electrode active material may be one having a P2 type structure as a main phase or one having a crystal structure other than a P2 type structure as a main phase. The positive electrode active material may be one in which the crystal structure serving as a main phase changes depending on the charge and discharge state thereof.

### 2.2 Chemical Composition

The positive electrode active material may comprise at least one element selected from Mn, Ni, and Co; Na; and O as constituent elements. Particularly, when the constituent elements include Mn; at least one of Ni and Co; Na; and O, especially when the constituent elements include at least Na, Mn, Ni, Co, and O, higher performance is easily ensured. However, in the positive electrode active material, for example, Na can be almost completely released by charging, and the molar concentration of Na can approach a limit near 0. In addition, the positive electrode active material can comprise the above element M. Further, the positive electrode active material can comprise additional impurity elements.

The chemical composition of the positive electrode active material having a P2 type structure may be represented by NaₐMnₓ₋ₚNi_{y-q}Co_{z-r}M_{p+q+r}O₂ (where 0.70<a≤1.40; x+y+z=1; and 0≤p+q+r<0.17, and M is at least one of B, Mg, Al, K, Ca, Ti, V, Cr, Fe, Cu, Zn, Ga, Ge, Sr, Y, Zr, Nb, Mo, and W). In the chemical composition, a is greater than 0.70 and may be 0.80 or greater, 0.90 or greater, 1.00 or greater or greater than 1.00, and is 1.40 or less and may be 1.35 or less, 1.30 or less, 1.25 or less, 1.20 or less, 1.15 or less, or 1.10 or less. The values of x, y, z, p, q, and r and the composition of O may be the same as those exemplified as the chemical composition of the Na containing transition metal oxide obtained in the step S1, and the descriptions thereof are omitted here.

### 2.3 Shape

The positive electrode active material may be particulate. The positive electrode active material particle may be a solid particle, may be a hollow particle, or may be one having voids.

The positive electrode active material particle may be a primary particle, or may be a secondary particle of a plurality of agglomerated primary particles. The average particle diameter (D50) of the positive electrode active material particles, for example, may be 1 nm or more, 5 nm or more, or 10 nm or more, and may be 500 μm or less, 100 μm or less, 50 μm or less, or 30 μm or less. Note that the average particle diameter D50 referred to in the present application is the 50% cumulative particle diameter (median diameter) in a volume-based particle size distribution determined by a laser diffraction/scattering method.

### 2.4 Other

The positive electrode active material can comprise components resulting from the above manufacturing steps as impurities. For example, the positive electrode active material may comprise a component derived from the reducing solution. Specifically, the positive electrode active material may contain an aromatic organic compound such as biphenyl. Further, the positive electrode active material may contain a ether compound such as tetrahydrofuran or dimethoxyethane.

### 3. Method of Manufacturing Sodium Ion Battery

The positive electrode active material manufactured as described above is used as, for example, a positive electrode active material of a Sodium ion battery. A method of manufacturing a sodium ion battery according to an embodiment may comprise, for example, manufacturing the positive electrode active material by the above method for manufacturing of the present disclosure, using the positive electrode active material manufactured to obtain a positive electrode active material layer, and using the positive electrode active material layer to obtain a sodium ion battery, as shown in FIG. 2. The method of manufacturing a sodium ion battery of the present disclosure may be the same method as in the prior art except that subsequent to the manufacture of the positive electrode active material of the present disclosure above, the positive electrode active material is used to obtain a positive electrode active material layer, for example, as follows.
(1) The positive electrode active material of the present disclosure above is dispersed in a solvent to obtain a positive electrode layer slurry. The solvent used in this case is not particularly limited, and water and various organic solvents can be used. The positive electrode layer slurry is applied on a surface of a positive electrode current collector using a doctor blade and then dried, whereby a positive electrode active material layer is formed on the surface of the positive electrode current collector to obtain a positive electrode.
(2) A negative electrode active material is dispersed in a solvent to obtain a negative electrode layer slurry. The solvent used in this case is not particularly limited, and water and various organic solvents can be used. The negative electrode layer slurry is applied on a surface of a negative electrode current collector using a doctor blade and then dried, whereby a negative electrode active material layer is formed on the surface of the negative electrode current collector to obtain a negative electrode.
(3) Layers are laminated so that an electrolyte layer (solid electrolyte layer or separator) is interposed between the negative electrode and the positive electrode to obtain a laminated body comprising a negative electrode current collector, a negative electrode active material layer, an electrolyte layer, a positive electrode active material layer, and a positive electrode current collector in this order. Additional members such as terminals are attached to the laminated body as needed.
(4) The laminated body is housed in a battery case. In the case of an electrolytic solution battery, a sodium ion battery is obtained by filling an electrolytic solution into a battery case, immersing the laminated body in the electrolytic solution, and sealing the laminated body within the battery case. Note that in the case of the electrolytic solution battery, the electrolytic solution may be contained in the negative electrode active material layer, the separator, and the positive electrode active material layer in the above stage (3).

### 4. Sodium Ion Battery

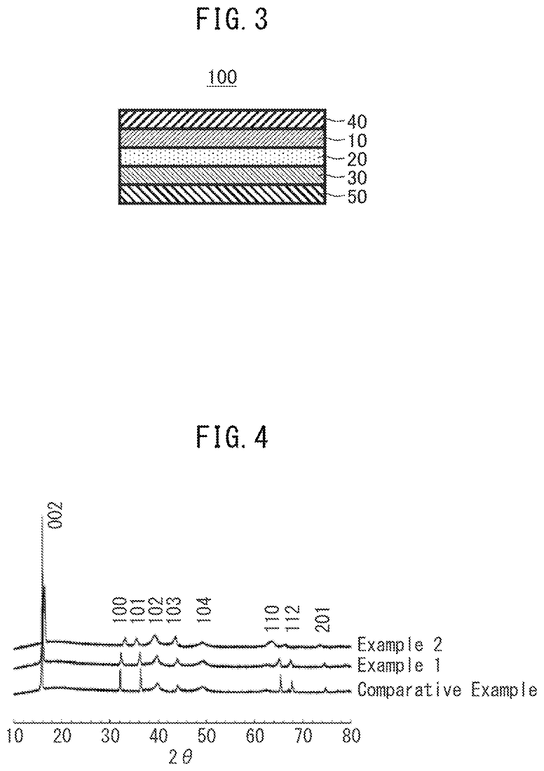

The technique of the present disclosure also has an aspect as a sodium ion battery. For example, as shown in FIG. 3, the sodium ion battery 100 according to one embodiment comprises a positive electrode active material layer 10, an electrolyte layer 20, and a negative electrode active material layer 30, wherein the positive electrode active material layer 10 comprises the above positive electrode active material of the present disclosure. As shown in FIG. 3, the sodium ion battery 100 can be provided with a positive electrode current collector 40 and a negative electrode current collector 50. In the sodium ion battery 100, features other than the positive electrode active material may be the same as in the prior art. For example, the features described in PTL 1 (JP 2012-201588 A) can be adopted.

### EXAMPLES

From the foregoing, one embodiment of the method of manufacturing a positive electrode active material of the present disclosure has been described. However, it is possible to modify the method of manufacturing a positive electrode active material of the present disclosure in various ways other than the above embodiments without departing from the spirit thereof. Hereinafter, the technique of the present disclosure will be further described in detail with reference to the Examples. However, the technique of the present disclosure is not limited to the following Examples.

### 1. Production of Positive Electrode Active Material

### 1.1 Coprecipitation Synthesis of Transition Metal Source

MnSO₄·5H₂O, NiSO₄·6H₂O, and CoSO₄·7H₂O were weighed to a target compositional ratio and dissolved in distilled water to a concentration of 1.2 mol/L to obtain a first solution. In a separate container, Na₂CO₃ was dissolved in distilled water to a concentration of 1.2 mol/L to obtain a second solution. The first solution and the second solution, each at 500 mL, were then added dropwise at a rate of about 4 mL/min into a reactor already loaded with 1000 mL of pure water. Upon the completion of the dropwise addition, the mixture was stirred at a stirring rate of 150 rpm at room temperature for 1 h. The precipitate was washed with pure water and subjected to solid-liquid separation with a centrifugal separator. The resulting precipitate was dried overnight at 120° C. and crushed with a mortar, fine particles were removed by gasflow classification, and mixed salt particles (transition metal source) comprising Mn, Ni, and Co were obtained.

### 1.2 Mixing of Transition Metal Source and Na Source (Na Coating)

Na₂CO₃ and distilled water were stirred to complete dissolution using a stirrer to produce a Na₂CO₃ aqueous solution. The above mixed salt particles were mixed into the Na₂CO₃ aqueous solution to obtain a slurry. The Na₂CO₃ and the above mixed salt particles were mixed so as to have a composition of Na_{0.7}Mn_{0.5}Ni_{0.2}Co_{0.3}O₂ after drying. The obtained slurry was dried by spray drying. Specifically, using a spray drying apparatus DL410, under the conditions of a slurry feed rate of 30 mL/min, an inlet temperature of 200° C., a circulating gas volume of 0.8 m³/min, and a spraying gas pressure of 0.3 MPa, surfaces of the above mixed salt particles were coated with Na₂CO₃ to obtain coated particles.

### 1.3 Firing of Coated Particles

An alumina crucible was used for firing of the coated particles in an electric furnace in an ambient air atmosphere. Specifically, the coated particles were subjected to a “first heating step”, a “pre-firing step”, a “second heating step”, a “main firing step”, and an “in-furnace cooling step”, as indicated in Table 1 below. The fired product was then removed from the electric furnace at 250° C. and crushed in a mortar in a dry atmosphere having a dew point of −30° C. or lower to obtain a Na containing transition metal oxide having a P2-type structure.

TABLE 1

| | | | | Heating or |
|---|---|---|---|---|
| | Starting | Ending | | cooling |
| | temperature | temperature | Time | rate |
| Step | (° C.) | (° C.) | (min) | (° C./min) |
| First heating | 25 | 600 | 115 | 5 |
| step | | | | |
| Pre-firing | 600 | 600 | 360 | 0 |
| step | | | | |
| Second | 600 | 900 | 100 | 3 |
| heating step | | | | |
| Main firing | 900 | 900 | 60 | 0 |
| step | | | | |
| In-furnace | 900 | 250 | 130 | 5 |
| cooling step | | | | |

### 1.4 Na Doping (Examples 1 and 2)

Biphenyl was mixed and dissolved in tetrahydrofuran (THF) to 1 mol/L in a glove box (Ar atmosphere) to obtain a biphenyl solution. Metal Na at the same mole as the biphenyl was further added in the biphenyl solution and stirred for 2 h to obtain a reducing solution comprising 1 mol/L of Na ions. The above Na containing transition metal oxide was added, immersed, and stirred in the obtained reducing solution for 24 h. After stirring, the Na containing transition metal oxide was washed with THF and subjected to solid-liquid separation by vacuum filtration. The resulting precipitate was dried overnight at 120° C. to obtain a positive electrode active material (Na containing transition metal oxide further doped with Na). By changing the molar ratio (Na ions/Na containing transition metal oxide) of Na ions contained in the reducing solution to Na containing transition metal oxide immersed in the reducing solution, as indicated in Table 2 below, a positive electrode active material of Example 1 and 2 was obtained.

### 1.5 Comparative Example

The Na containing transition metal oxide without further Na doping and after out of furnace cooling and mortar grinding were used as positive active materials as they were.

### 2. Determination of Chemical Composition and Crystal Structure of Positive Electrode Active Material

The chemical composition of the positive electrode active material in each Examples 1 and 2 and Comparative Example were determined by ICP analysis. Examples 1 and 2 and Comparative Example all had a chemical composition represented by Na_{X}Mn_{0.5}Ni_{0.2}Co_{0.3}O₂, i.e., the compositional ratios of the transition metals were the same but the compositional ratio of Na varied. Further, X-ray diffraction measurements were carried out on the positive electrode active material in each of Examples 1 and 2 and Comparative Example, and the crystal structure was identified. X-diffraction pattern of each is shown in FIG. 4. As shown in FIG. 4, the positive electrode active materials of Examples 1 and 2 and Comparative Example all had a P2 type crystal structure.

### 3. Production of Coin Cell

The above positive electrode active material, acetylene black (AB) as a conductive material, and PVdF as a binder were weighed so as to have a mass ratio of positive electrode active material: AB: PVdF=85:10:5, and dispersed and mixed in N-methyl-2-pyrrolidene to obtain a positive electrode slurry. The positive electrode slurry was applied on an Al foil and dried overnight at 120° C. to obtain a positive electrode. The resulting positive electrode, an electrolytic solution (solvent: EC/DMC, electrolyte: NaPF₆, concentration:1M), and a metallic Na foil as a negative electrode were used to produce a coin cell (CR2032).

### 4. Evaluation of Coin Cell

The coin cell was charged and discharged at a voltage range of 1.5 to 4.5 V at a rate of 0.1 C (1 C=200 mA/g) in an isothermal chamber maintained at 25° C., and the initial charging capacity and initial discharging capacity were measured.

### 5. Evaluation Results

Table 2 below shows the “molar ratio (Na ions/Na containing transition metal oxide) of Na ions contained in the reducing solution to Na containing transition metal oxide immersed in the reducing solution” in the Na doping step, the Na amount (value of X in Na_{X}Mn_{0.5}Ni_{0.2}Co_{0.3}O₂) determined by ICP analysis, and the initial charging capacity and initial discharging capacity of the coin cell for each of Examples 1 and 2 and Comparative Example.

TABLE 2

| | Molar | | Initial Charging | Initial Discharging |
|---|---|---|---|---|
| | Ratio | X | Capacity (mAh/g) | Capacity (mAh/g) |
| Example 1 | 0.2 | 0.83 | 187 | 190 |
| Example 2 | 0.4 | 1.05 | 221 | 198 |
| Comp. Example | no doping | 0.61 | 140 | 188 |

As shown in Table 2, the positive electrode active material according to the comparative example not subjected to further Na doping after the main firing, the value of X was lower than 0.70, whereas the positive electrode active material according to Examples 1 and 2 further doped with Na in a step different from the main firing, the value of X became more than 0.70. Thus, the coin cell according to Examples 1 and 2 remarkably increased the initial charge capacity and the initial discharge capacity than the coin cell according to the comparative example. In other words, it has been found that a potential of a capacity as a P2 type positive electrode active material can be extracted by obtaining a Na containing transition metal oxide having a P2 type structure and then further doping Na.

Although the above Examples exemplify a case where coated particles comprising Na and a transition metal were obtained via a coprecipitation method and spray drying, the production conditions of the coated particles are not limited thereto. Further, although the above Examples exemplify a case where coated particles and a P2 type Na containing transition metal oxide having a specific chemical composition were produced and the Na containing transition metal oxide was doped with Na, the chemical composition of the P2 type positive electrode active material is not limited thereto. Furthermore, although the above Examples exemplify a case where a specific reducing solution was used for doping with Na, the reducing solution is not limited thereto. Moreover, it is considered that various conditions can be changed as along as Na can be further doped after main firing in a step separate from the main firing.

### REFERENCE SIGNS LIST

10 Positive electrode active material layer
20 Electrolyte layer
30 Negative electrode active material layer
40 Positive electrode current collector
50 Negative electrode current collector
100 Sodium ion battery

1. A method of manufacturing a positive electrode active material, the method comprising:
obtaining a Na containing transition metal oxide having a P2 type structure, and
further doping the Na containing transition metal oxide with Na.

2. The method according to claim 1, wherein
the Na containing transition metal oxide is further doped with Na by bringing a reducing solution comprising Na ions into contact with the Na containing transition metal oxide.

3. A method of manufacturing a sodium ion battery, the method comprising:
producing a positive electrode active material by the method according to claim 1,
using the positive electrode active material to obtain a positive electrode active material layer, and
using the positive electrode active material layer to obtain a sodium ion battery.

4. A positive electrode active material,
having a P2 type structure, and
having a chemical composition represented by NaₐMnₓ₋ₚNi_{y-q}Co_{z-r}M_{p+q+r}O₂ (where, 0.70<a≤1.40, x+y+z=1, 0≤p+q+r<0.17, M is at least one of B, Mg, Al, K, Ca, Ti, V, Cr, Fe, Cu, Zn, Ga, Ge, Sr, Y, Zr, Nb, Mo and W).

5. A sodium ion battery, comprising a positive electrode active material layer, an electrolyte layer, and a negative electrode active material layer, wherein
the positive electrode active material layer comprises a positive electrode active material according to claim 4.
